(19) United States
(12) Patent Application Publication
(10) Pub. No.: US 2005/0238355 A1
(43) Pub. Date: Oct. 27, 2005

(54) Device for the switching of optical switch per IP address

(76) Inventors: Rogerio Lara Leite, Jaguariuna/SP (BR); Eduardo Mobilon, Americana/SP (BR); Helio Silvino De Almeida Prata, Campinas/SP (BR); Danilo Cesar Dini, Valinhos/SP (BR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/105,462

(22) Filed: Apr. 14, 2005

(30) Foreign Application Priority Data
Apr. 15, 2004 (BR) PI 0401601-7

(51) Int. Cl. H04B 10/20

(52) U.S. Cl. 398/58

(57) ABSTRACT

“DEVICE FOR THE SWITCHING OF REMOTE OPTICAL SWITCH PER IP ADDRESS” 12, conceived to extend the supervision distance range of centralized optical supervision systems, containing one centralized optical supervision system (COS) 5b, comprising one microcomputer that manages, through a data copper network 6b, several remote points of supervision RPS 7c, each of them formed by one OTDR, one microcomputer 3d and one optical switch 4c; and commanding, through the data copper network 6b, a plurality of remote optical switches 12, individually identified by one fixed IP address, being these remote optical switches 12 displayed in the optical fibers that are connected to the output channels of the optical switch 4c, known as optical fibers, which receive at least one remote optical switch device 12, encompassing one ETHERNET INTERFACE that receives Ethernet standard packages and performs the treatment of the TCP/IP protocol, extracting data contained in it; a microcontroller that receives and decodes data coming from the ETHERNET INTERFACE, obtaining the indication of the channel as well as the switching commands; and an optical switch 4d that, commanded by the microcontroller, switches to the channel that is indicated by the RPS 7c, so that the route that this point of supervision intends to supervise is established.

In general terms, the present invention refers to a device which was conceived to remotely command the switching of a remote optical switch used to increase the capacity of supervision in high capillarity optical networks.

The use of optical communications by telephony service providers has been increasing considerably as time passes by. The advantages of using fiber optics as a means of transmission are uncountable in relation to metallic conductors. One of these advantages is the high transmission capacity.

At first, the optical networks were used only in the main axes of communication routes. However, the increasing raise in data traffic and the consequent need to broaden traffic capacity and speed, also in communications network branches, have led the optical network each time nearer the final user. As a result, we have a gradual increase in the capillarity of this optical network and in the consequent increase in difficulties to supervise the network.

As usual in copper networks, optical networks also are subject to frequent service interruptions which result from the fall of trees on routes, poles or support towers, underground gallery floods, and even cable plunder, since cable burglars cannot tell an optical cable from a copper cable, and happen to discover the mistake only after having damaged it. Such problems result in communication interruption and therefore in significant losses for the service providers.

Faced with the above mentioned occurrences, one of the greatest problems for the companies consists of prompt failure detection, location, diagnosis, and repair failures within the optical fiber network. This problem is made even worse by the constitution of the network itself, whose main branches (Backbones) pass several times through remote regions, with difficult access, and the metropolitan networks are mostly underground networks, making it difficult to find and repair failures.

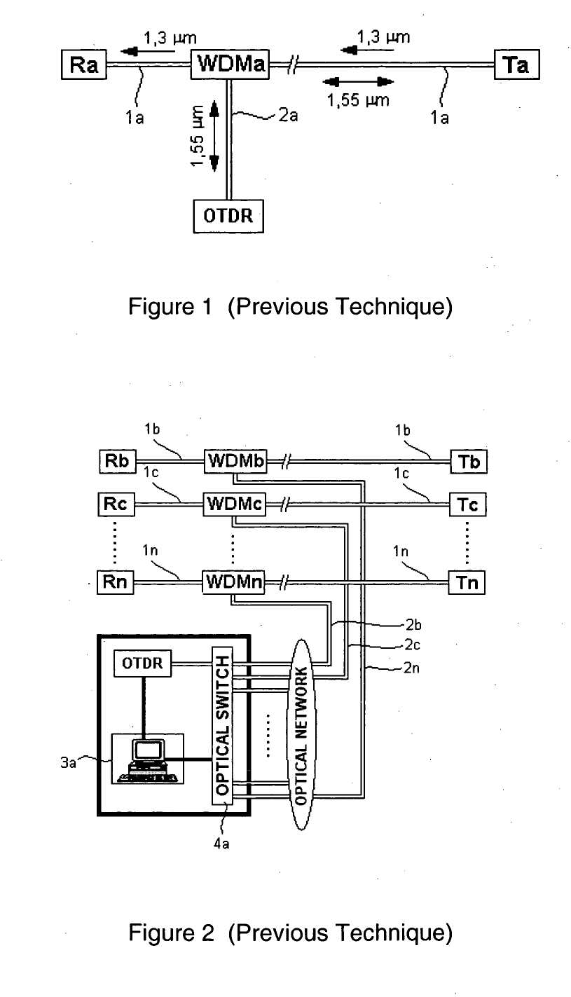

Iran Lima Gonçalves et al (“Sistema de supervisão on-line para rede externa óptica”, Revista Telebrás, Edição Tecnologia, 15(54): December 1991) describe an optical network supervision method. According to this method, whose conception is represented in FIG. 1, the normal communication traffic linking two central offices is made through the optical signal in the 1.3 μm window, issued from transmitter Ta to receiver Ra through fiber 1a. The supervision of this fiber 1a includes the installation, next to the receiver Ra, of an optical Wavelength Division Multiplexer (WDM) a, through which a supervision signal of 1.55 μm is injected in the fiber. This Optical Time Domain Reflectometer (OTDR) signal is connected to the WDM multiplexer a through the fiber 2a. In order to avoid synchronism loss in detector Ra due to the superposition of the OTDR signal (1.55 μm) with the transmission signal (1.3 μm), the optical OTDR signal is injected in fiber 1a, in the opposite direction of the transmission of the 1.3 μm communication signal. The backscattering of this signal is received by the WDM a and sent back to the OTDR, which measures the backscattering curve. As the backscattering curve is closely associated with the length of the fiber where the signal travels, it is possible, by observing this curve, to determine the occurrence of interruption or degradation of the optical signal transmission in fiber 1a, and to determine from what distance from the OTDR such interruption or degradations occurs.

The study in question also describes a conception according to which the OTDR supervision capacity is enhanced, in which the OTDR supervision signal is taken to a plurality of optical fibers (1b, 1c, . . . , 1n) by using an additional microcomputer 3a and an optical switch 4a, as shown in FIG. 2. Within this conception of enlarged supervision, the microcomputer 3a, which has specific supervision/control software, commands optical switch 4a to lead the OTDR signal to one of the WDM optical multiplexers (b, c, . . . , n), connecting the mentioned OTDR to one of the fibers (1b, 1c, . . . , 1n) and then supervise it. The backscattering curve measured by the OTDR is sent to microcomputer 3a, which compares this measured curve with the standard curve of the fiber, which is stored in its memory and, through this comparison, determines whether any interruption or degradation in signal transmission has taken place, and from what distance from the OTDR the interruption or degradation of the signal has occurred. If need be, it produces appropriate reports and/or alarms.

In the enhanced conception described above, the supervision device comprises one microcomputer 3a, one OTDR and an optical switch 4a. Its supervision capacity is circumscribed to the optical fibers that are connected to the channels of the optical switch 4a through the corresponding WDM optical multiplexers (b, c, . . . , n).

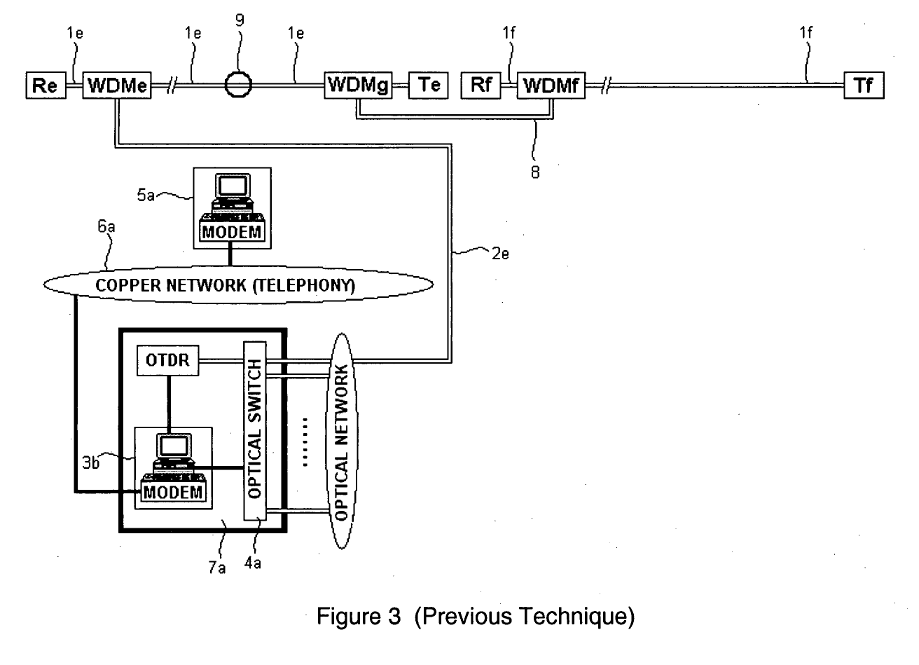

One evolution in the previously described supervision process was proposed by Iran Lima Gonçalves et al (“Outside Plant Optical Network Supervision”, Revista Telebrás, Edição Tecnologia, 17(58): October 1993). This evolution, which is represented in FIG. 3, consists of providing a modem to a microcomputer 3a of the supervision device belonging to the previous conception, being the supervision device of this other conception made of a microcomputer with modem 3b, the OTDR and the optical switch 4a. This device is known as Remote Point of Supervision (RPS) 7a. This additional supervision conception also comprises a Centralized Optical Supervision (COS) system 5a, which consists of one microcomputer with a modem, to which a plurality of RPS 7a is interconnected through the telephony copper network 6a. Specific software items complement this conception. They reside in RPS 7a and in COS 5a, allowing the coordinate application of supervision procedures by the former, and the centralized management by the latter.

In this centralized supervision conception, the COS 5a is normally placed in the center of the management, from which it controls the respective RPS 7a, which are distributed throughout the optical network according to the previously established supervision plan.

Periodically or when manually commanded, the RPS 7a accomplish the measurement in fibers under their supervision. They also inform the COS 5a about the operational status of these fibers. The COS processes the information, sends suitable alarms referring to the degradation or to failures found in supervised fibers, and updates the plant operational map, in addition to storing information in its database to form a record.

Due to concentrating the supervision information that comes from several RPS 7a in a unique place (COS 5a), this centralized supervision conception makes the failure diagnosis/location process more effective in the optical network, largely reducing the repair time of an optical cable. However, the use of a telephony copper network 6a limits the traffic speed involving supervision commands and information. In addition, increasing the supervision capacity of the centralized system requires the installation of new remote points of supervision RPS 7a, a solution that increases significantly the costs of deployment of the supervision system, owing to the microcomputers 3b and OTDR present in the additional RPS 7a.

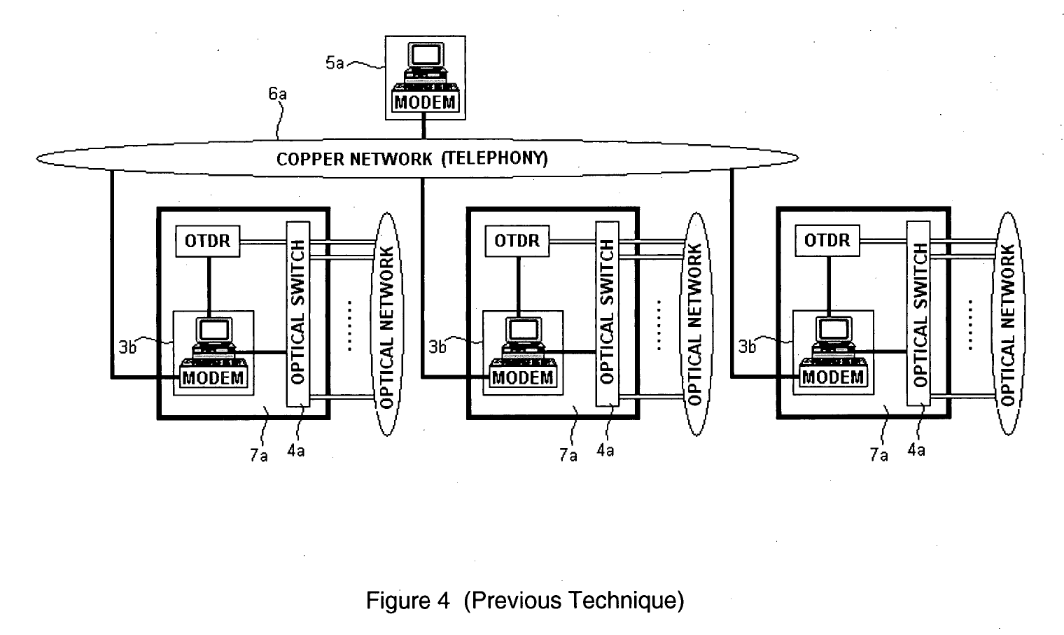

One evolution of the centralized supervision method in the optical network was described by Hélio Silvio de Almeida Prata (“A new approach on optical fiber cable network supervision system”, International Wire and Cable Symposium, November 17 Thru 20, 1997, 530(533)). This conception, which is represented in FIG. 4, consists of an improvement in the previously described centralized supervision, differing from the last one because it extends the RPS 7a supervision distance range, uniting different fiber segments through the by-pass 8, so that a continuous route is established, in which supervision signal travels, providing the precise location of the defective point is made possible.

As usual for the previously described conceptions, in the present conception the RPS 7a 1.55 μm supervision signal is also injected in fiber 1e through WDM e in the opposite direction of the 1.3 μm communication signal, which is transmitted from transmitter Te to receiver Re, and from transmitter Tf to receiver Rf. In this conception, problems are simulated in each of the components that are present in the route to be supervised. For instance, WDM e, the humidity sensor 9, WDM g and WDM f represented by FIG. 4 and, in addition, connectors and other unrepresented components. In each simulation there is a scanning performed with the OTDR that belongs to the RPS 7a responsible for the supervision of the route that encompasses fibers 1e, 8 and 1f, from which a route standard curve is obtained with the position of each present component. Through this procedure, a standard backscattering curve is obtained from each of the RPS 7a-supervised routes. The curves are stored in a database of microcomputer 3b of the RPS 7a. Thus, when a defect is detected in the supervised route, the OTDR traces the backscattering curve of this route and transmits it to the respective microcomputer 3b, which compares the curve with the standard curve of the route that is stored in its database. So it identifies whether there is any failure or degradation and in each point of the route it is occurring.

The merit of this conception is in the fact that the mapping uses components as reference marks. This allows identifying from what distance from the references any interruption or degradation signal is occurring in the supervised route. It also extends the supervision distance range through the utilization of a plurality of by-pass 8 linking different fiber segments so that a unique route, in which the supervision signal continuously travels (1.55 μm), is established and, therefore, is able to go round the central offices which are distributed along the supervised route.

In spite of this conception extending the OTDR supervision distance range, its applicability is limited to the number of channels available in the OPTICAL SWITCH and to the fibers whose availability in the network permits their serial linking. In addition, as in the conceptions mentioned before, the utilization of the telephony copper network 6a consists of a device that limits the speed of supervision commands and information, as well as the costs of supervision system expansion are increased by microcomputers 3b and OTDR present in the additional RPS 7a.

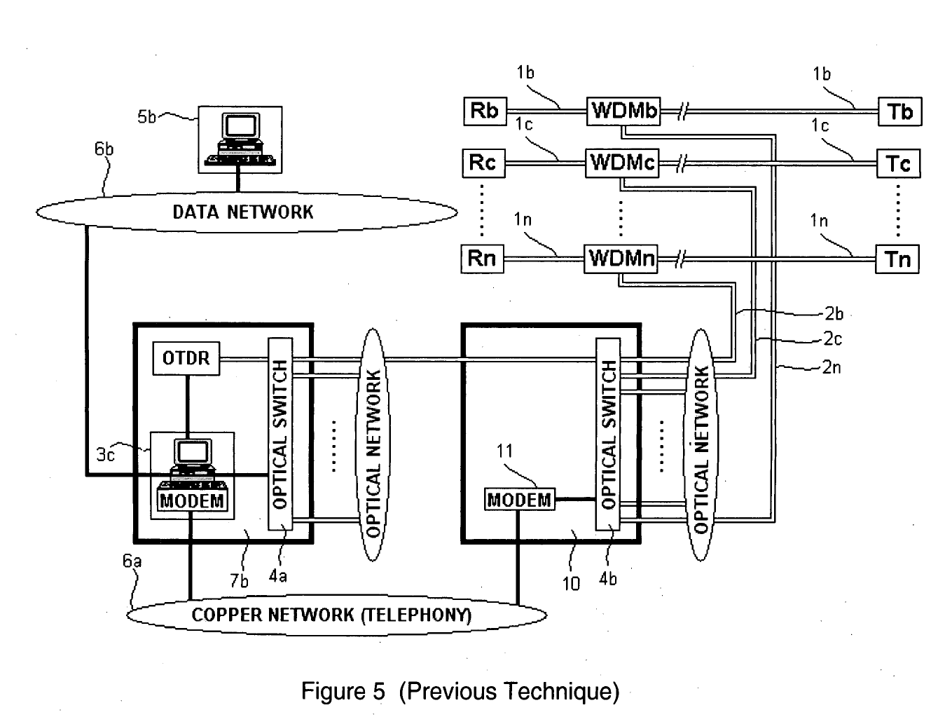

At another conception of the state of technique, which is represented by FIG. 5, the RPS supervision capacity is enhanced through the utilization of remote optical switch devices 10, each of them composed of a modem 11 linked to an optical switch 4b. In this conception, the microcomputer 3c of RPS 7b commands directly the optical switch 4b and, through the telephony copper network 6a and modem 11, the optical switch 4b, thus establishing the optical route that the RPS 7b intends to supervise.

In this conception, although the communication between the centralized optical supervision system 5b and the remote supervision devices RPS 7b is performed in greater speed, through the data network the communication between RPS 7b and respective remote switching devices 10 continues to be provided at a low speed through the telephony copper network 6a. Moreover, the need to use modems 11 to increase the supervision distance range of the RPS 7b results in a significant increase in the costs of the supervision system deployment.

Another problem encountered in the existent conceptions is that they present a high power consumption, which makes them inappropriate for regions where this kind of energy is not available.

Owing to the facts exposed above, the objective of the present invention is to provide one “DEVICE FOR THE SWITCHING OF REMOTE OPTICAL SWITCH PER IP ADDRESS”, which is able to:
a) allows increasing RPS supervision capacity without using the telephony copper network 6a;
b) allows increasing communication speed involving the RPS and the remote optical switch devices;
c) allows increasing system supervision capacity without using additional microcomputers;
d) presents lower power consumption, being therefore appropriate for regions where conventional power supply is absent, where the equipment requires solar energy.
e) present enhanced portability (low weight and volume), being particularly adequate to be installed in poles, transmission towers, and other similar applications;
f) presents decreased maintenance needs, incorporating more simple electronics.

The proposed objectives and others are reached through the “DEVICE FOR THE SWITCHING OF REMOTE OPTICAL SWITCH PER IP ADDRESS’ conceived to extend the supervision distance range of centralized optical supervision systems, containing one centralized optical supervision system (COS) 5b, comprising one microcomputer that manages, through a data copper network 6b, several remote points of supervision RPS 7c, each of them formed by one OTDR, one microcomputer 3d and one optical switch 4c; and commanding, through the data copper network 6b, a plurality of remote optical switches 12, individually identified by one fixed IP address, and displayed in the optical fibers that are connected to the output channels of the optical switch 4c, the so-called optical fibers, which receive at least one remote optical switch device 12, encompassing one ETHERNET INTERFACE that receives Ethernet standard packages and performs the treatment of the TCP/IP protocol, extracting data contained in it; a microcontroller that receives and decodes data coming from the ETHERNET INTERFACE, obtaining the indication of the channel as well as the commands which are needed for the switching of the optical switch 4d; and one optical switch 4d that, commanded by one microcontroller, switches to the channel that is indicated by the RPS 7c, so that the route that this point of supervision intends to supervise is established.

The invention will be better understood according to the detailed description and the corresponding figures, such as:

FIG. 1—Represents a system of the known technique that uses an OTDR and a WDM a to supervise an optical fiber link.

FIG. 2—Represents an automatized system of the known technique that uses a unique OTDR to supervise the plurality of optical fiber links.

FIG. 3—Represents a centralized system of the known technique that uses one COS 5a to generate a plurality of remote points of supervision RPS 7a.

FIG. 4—Represents a centralized system of the known technique, in which either the component or the damaged network point is located through the comparison of curves.

FIG. 5—Represents a centralized supervision system of the known technique, in which the RPS 7b commands a plurality of remote optical switches 10, so that the supervision is extended to other optical network routes.

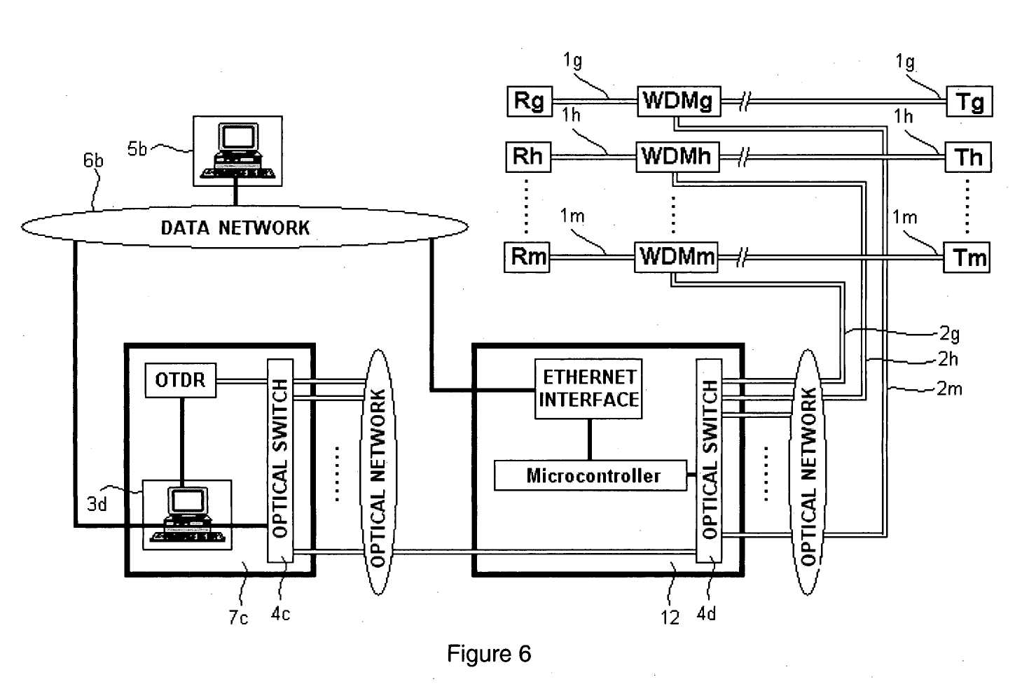

FIG. 6—Represents a centralized supervision system that uses one of the implementation ways of the device which is the object of the present invention.

According to the principles of the present invention, the “DEVICE FOR THE SWITCHING OF REMOTE OPTICAL SWITCH PER IP ADDRESS” 12, represented by FIG. 6 through one of its implementation ways, was conceived to extend the supervision distance range of the centralized optical supervision systems. It comprises one centralized optical supervision system COS 5b, which is formed by one microcomputer that manages, through the data copper network 6b, several remote points of supervision RPS 7c, each of them comprising one OTDR, a microcomputer 3d and one optical switch 4c; and commanding, through the data copper network 6b, a plurality of remote optical switches 12, individually identified by one fixed IP address, and displayed in the optical fibers that are connected to the output channels of the optical switch 4c, the so-called optical fibers, which receive at least one remote optical switch device 12, encompassing one ETHERNET INTERFACE that receives Ethernet standard packages and performs the treatment of the TCP/IP protocol (disassembles the stack), extracting data contained in it (payload); a microcontroller that receives and decodes data coming from the ETHERNET INTERFACE, obtaining the indication of the channel as well as the commands which are needed for the switching of the optical switch 4d; and one optical switch 4d that, commanded by one microcontroller, switches to the channel that is indicated by the RPS 7c, so that the route that this point of supervision intends to supervise is established. After the switching operation, the optical switch 4d informs the microcontroller whether the switching was accomplished successfully or not. This information is transmitted to the ETHERNET INTERFACE and from it to the RPS 7c through the data network 6b.

Specific software complements the supervision system. These software items reside in the remote optical switch devices 12, in RPS 7c and in COS 5b, which allow the coordinate application of supervision procedures by the first and the second, and of the centralized management of supervision by the third.

The Centralized Optical Supervision system COS 5b, which usually is located in the center of the telecommunications company management, is basically aimed at sending alarms and keeping updated the map that indicates the operational conditions of the supervised routes, based on the supervision information received by the respective RPS 7c, so that the optical plant manager is always aware of operational circumstances.

The execution of the optical network supervision is made by the remote points of supervision RPS 7c, which check, in real time, its operational status, so that the precise location of a given failure is immediately determined.

The remote points of supervision RPS 7c are usually located in central offices, methodically chosen according to the optical network supervision system project.

To extend the supervision distance range of the system to other optical network branches, each of the routes supervised by the RPS 7c receives at least one remote optical switch device 12, in which the optical switch 4d has its common channel linked to the optical fiber that comes from the optical switch 4c, and the additional channels linked to the new supervised routes (1g, 1h, . . . , 1m), through the WDMs (g, h, . . . , m).

In general terms, this conception reduces the deployment costs of the supervision system significantly, eliminating the need to use, in each additional supervision point, a complete RPS 7c, which is substituted by a remote optical switch device 12. Thus, the costs related to the OTDR and to the microcomputer 3d are eliminated.

Due to not using a modem or a microcomputer, the conception of the remote optical switch device, which is the object of the present invention patent, presents a lower power consumption, so that it can even be supplied by solar energy converters. In addition, it presents enhanced portability (lower weight and volume), features which make it particularly indicated to be installed in towers and poles located in remote localities, where there is neither power nor landmarks, which have a data copper network 6b through which the RPS 7c communicates with the remote optical switch device 12. These features, when added to a low deployment/maintenance cost, make this conception appropriate for any type of application, including conventional installations supplied with thorough infrastructure.

According to the system supervision procedure represented by FIG. 6, the microcomputer 3d transmits to the data network 6b a command signaling comprising a TCP/IP protocol, encompassing the IP address of the remote optical switch device 12 to be switched, and a proprietary protocol containing data to indicate the channel to be switched, and the commands based on which the optical switch 4d should be switched to establish the route that the RPS 7c intends to supervise. In the remote optical switch device 12, the TCP/IP protocol is decoded by the ETHERNET INTERFACE, which checks if it is destined to that remote optical switch 12 and, if so, sends the contents of the TCP/IP package (data) to the microcontroller, where they are interpreted. The indication of the channel is obtained, as well as other commands, based on which the microcontroller commands the switching of the optical switch 4d. After the switching operation, the optical switch 4d informs the microcontroller whether the switching was accomplished successfully or not. This information is transmitted to the ETHERNET INTERFACE and from it to the RPS 7c through the data network 6b.

Through the information received from the remote optical switch 12, after checking whether the switching was properly accomplished, resulting in the establishment of the route to be supervised, microcomputer 3d, through its parallel port, commands the optical switch 4c to switch to the route where the remote optical switch device 12 is located and, through its serial port, commands the OTDR to transmit, through the established route, the supervision signal, whose backscattering curve is received by the OTDR and transmitted to microcomputer 3d, which compares it with the reference curves that are stored in its database. Through this comparison of curves it is possible to identify if there is any defect in the route and the precise location of this problem.

In order to avoid the interference with receivers R (g, h, . . . , m) of the optical network, the supervision optical signal is transmitted at a frequency higher than the normal optical network traffic frequency and in the opposite direction of this traffic. So, for example, if the network normal traffic frequency is 1.3 μm, the supervision signal of this network is transmitted in the 1.55 μm window. If the 1.3 μm signal transmission direction is from the transmitters T (g, h, . . . , m) to the receivers R(g, h, . . . , m), the 1.55 μm supervision signal will be transmitted from the WDMs (g, h, . . . , m) to the transmitters T (g, h, . . . , m).

The supervision conception described above can be broadened by connecting, in each route originated in optical switch 4d, one or more additional remote optical switch devices 12, so that a supervision network is established, which is made of a plurality of remote optical switch devices 12 interconnected in chain to the same RPS 7c, being the remote supervision devices, so displayed, commanded by RPS 7c through the data cooper network 6b and through the respective IP addresses, so that the optical switches 4d of the chain are switched properly, and the intended supervision routes are established.

Although the present invention has been described through the remote optical switch device 12, used to supervise optical networks, it is also possible to employ it to establish the routing of optical fiber networks. This additional way to use the RPS 7c is changed by a conventional optical transmitter, which is commanded to transmit the optical signal containing the convenient commands.

Although the invention has been described in connection with certain favorite accomplishment modalities, it should be understood that the invention is not supposed to be limited by those particular modalities. On the contrary, all the possible alternatives, changes and equivalent actions are intended to be covered within the spirit and the scope of invention.

1- “DEVICE FOR THE SWITCHING OF REMOTE OPTICAL SWITCH PER IP ADDRESS” (12), conceived to extend the supervision distance range of centralized optical supervision systems, containing one centralized optical supervision system (COS) (5b), comprising one microcomputer that manages, through a data copper network (6b), several remote points of supervision RPS (7c), each of them formed by one OTDR, one microcomputer (3d) and one optical switch (4c); and commanding, through the data copper network (6b), a plurality of remote optical switches (12), characterized as it is individually identified by one fixed IP address, being these remote optical switches (12) displayed in the optical fibers that are connected to the output channels of the optical switch (4c), known as optical fibers, which receive at least one remote optical switches device (12), encompassing one ETHERNET INTERFACE that receives ethernet standard packages and performs the treatment of the TCP/IP protocol, extracting data contained in it; a microcontroller that receives and decodes data coming from the ETHERNET INTERFACE, obtaining the indication of the channel as well as the switching commands; and an optical switch (4d) that, commanded by the microcontroller, switches to the channel that is indicated by the RPS (7c), so that the route that this point of supervision intends to supervise is established.

2- “DEVICE FOR THE SWITCHING OF REMOTE OPTICAL SWITCH” (12) according to claims 1, characterized by the fact that the TCP/IP command signaling destined to it comprises its IP address, the identification of the channel to which the optical switch (4d) is supposed to switch.

3- “DEVICE FOR THE SWITCHING OF THE REMOTE OPTICAL SWITCH”, according to claim 1, characterized by the fact that, after switching, the optical switch (4d) informs the microcontroller whether the switching was accomplished or not.

4- “DEVICE FOR THE SWITCHING OF THE REMOTE OPTICAL SWITCH”, according to claims 1 and 3, characterized by the fact that, after being informed whether the optical switch (4d) switched or not, the microcontroller transmits the information to the RPS (7c), which checks whether the switching occurred.
